(19) United States
(12) Patent Application Publication
(10) Pub. No.: US 2016/0327068 A1
(43) Pub. Date: Nov. 10, 2016

(54) QUICK-ACTION BLEEDER VALVE DEVICE FOR PNEUMATIC ACTUATORS OF PNEUMATIC SYSTEMS, AND PNEUMATIC SYSTEM HAVING A QUICK-ACTION BLEEDER VALVE DEVICE OF THIS TYPE

(71) Applicant: KNORR-BREMSE SYSTEME FUER NUTZFAHRZE GMBH, München (DE)

(72) Inventors: Jan GREBE, Muenchen (DE); Thomas BEMETZ, Muenchen (DE); Kai WERNER, Bietigheim-Bissingen (DE); Dirk BRENNER, Stuttgart (DE); Zsigmond CSOMA, Perbal (HU)

(21) Appl. No.: 15/110,631

(22) PCT Filed: Dec. 19, 2014
(86) PCT No.: PCT/EP2014/078684

§ 371 Date: Jul. 8, 2016

(30) Foreign Application Priority Data
Jan. 9, 2014 (DE) 10 2014 100 187.7

(51) Int. Cl. F15B 13/02; F15B 13/04; B60T 15/52; F15B 15/20

(52) U.S. Cl. CPC F15B 13/024; F15B 15/202; F15B 13/0405; B60T 15/52; F15B 2215/00

(57) ABSTRACT

A quick-action bleeder valve device for a pneumatic actuator of a pneumatic system, includes: a housing; a first connection which is connectable to a chamber of the actuator, which chamber can be ventilated and bled; a second connection which is connectable directly or indirectly to a compressed air source; a flow duct, formed in the housing, between the first connection and the second connection, the flow duct being constricted at a constriction point or throttle point by a reduced flow cross section; a diaphragm valve, arranged in the housing, including at least one diaphragm which interacts with a valve seat, wherein in an open position of the diaphragm valve, in which the diaphragm is lifted off from the valve seat, a pressure sink is connected to the first connection, and in a closed position of the diaphragm valve, in which the diaphragm is seated on the valve seat in a seal-forming fashion, this connection is interrupted; wherein at least part of a first effective area of the diaphragm, which effective area pushes the diaphragm valve into the open position under pressure loading, is loaded at least by a third pressure prevailing in a first section of the flow duct between the first connection and the constriction point or throttle point, wherein a second effective area of the diaphragm, which effective area pushes the diaphragm valve into the closed position under pressure loading, is loaded by a second pressure prevailing in the reduced flow cross section at the constriction point or throttle point or by a first pressure prevailing in a second section of the flow duct between the second connection and the constriction point or throttle point, wherein the diaphragm is pushed into the closed position by a pressure spring arrangement, and wherein the first effective area, the second effective area, the pressure spring arrangement and the flow cross sections in the first section, in the second section and at the constriction point or throttle point of the flow duct are configured so that: (i) in the case of a ventilation flow, directed from the second connection to the first connection, for ventilating the pneumatic actuator by the compressed air source, the closing forces which act on the second effective area and originate from the second pressure or from the first pressure and from that of the pressure spring arrangement hold the diaphragm valve in the closed position, or move it into said position, counter to the effect of the opening forces which act on the first effective area and originate at least from the third pressure, and (ii) in the case of a bleeding flow, directed from the first connection to the second connection, for bleeding the pneumatic actuator, the opening forces which act on the first effective area and originate at least from the third pressure hold the diaphragm valve in the open position, or move it into said position, counter to the effect of the closing forces which act on the second effective area and originate from the second pressure or from the first pressure and from that of the pressure spring arrangement.

### FIELD OF THE INVENTION

The invention is based on a quick-action bleeder valve device for pneumatic actuators of pneumatic systems, as well as on a pneumatic system containing at least one such quick-action bleeder valve device.

### BACKGROUND INFORMATION

In the case of utility vehicles, in addition to pneumatic brake cylinders of pneumatic or electro-pneumatic brake systems as actuators there are also air suspension systems or pneumatic clutch and/or transmission systems actuators, for example air spring bellows, which have to be ventilated and bled within short time periods and with a certain gradient. In particular, when vehicle movement dynamic systems such as ABS, traction control systems or ESP are on board, stringent requirements are made of the dynamics of pneumatic brake cylinders.

In the case of pneumatic or electro-pneumatic brake systems, the pneumatic brake pressure in the brake cylinders is usually modulated by a relay valve which is pilot-controlled by a control pressure of an electro-magnetic inlet/outlet valve combination. Even if the relay valve can ensure the required ventilation gradients and ventilation times, the bleeding requirements cannot be met in many cases. In this case, a quick-action bleeder valve device which is arranged between the working output of the relay valve and the brake cylinder is helpful.

### SUMMARY OF THE INVENTION

The present invention is therefore based on the object of making available a quick-action bleeder device which permits the fastest possible bleeding of a pneumatic actuator of a pneumatic system and at the same time is of a simple configuration. Furthermore, such a quick-action bleeder device is also to be arranged and used in a pneumatic system.

This object may beis achieved according to the invention by the features described herein.

The present invention is believed to present for the first time a quick-action bleeder valve device for pneumatic actuators of pneumatic systems, having

a) a housing,

b) a first connection which can be connected to a chamber of the actuator, which chamber can be ventilated and bled, and

c) a second connection which can be connected directly or indirectly to a compressed air source,

d) a flow duct, formed in the housing, between the first connection and the second connection, said flow duct being constricted at a constriction point or throttle point by a reduced flow cross section,

e) a diaphragm valve which is arranged in the housing and comprises at least one diaphragm which interacts with a valve seat, wherein in an open position of the diaphragm valve, in which the diaphragm is lifted off from the valve seat, a pressure sink is connected to the first connection, and in a closed position of the diaphragm valve, in which the diaphragm is seated on the valve seat in a seal-forming fashion, this connection is interrupted, and wherein

f) at least part of a first effective area of the diaphragm, which effective area pushes the diaphragm valve into the open position under pressure loading, is loaded at least by a third pressure prevailing in a first section of the flow duct between the first connection and the constriction point or throttle point, and

g) a second effective area of the diaphragm, which effective area pushes the diaphragm valve into the closed position under pressure loading, is loaded by a second pressure prevailing in the reduced flow cross section at the constriction point or throttle point or by a first pressure prevailing in a second section of the flow duct between the second connection and the constriction point or throttle point, and

h) the diaphragm is pushed into the closed position by pressure spring arrangement, wherein

i) the first effective area, the second effective area, the pressure spring arrangement and the flow cross sections in the first section, in the second section and at the constriction point or throttle point of the flow duct are configured in such a way that

i1) in the case of a ventilation flow, directed from the second connection to the first connection, for ventilating the pneumatic actuator by the compressed air source, the closing forces which act on the second effective area and originate from the second pressure or from the first pressure as well as from that of the pressure spring arrangement hold the diaphragm valve in the closed position, or move it into said position, counter to the effect of the opening forces which act on the first effective area and originate at least from the third pressure, while

i2) in the case of a bleeding flow, directed from the first connection to the second connection, for bleeding the pneumatic actuator, the opening forces which act on the first effective area and originate at least from the third pressure hold the diaphragm valve in the open position, or move it into said position, counter to the effect of the closing forces which act on the second effective area and originate at least from the second pressure hold or from the first pressure and from that of the pressure spring arrangement.

According to a first variant, the second effective area of the diaphragm is loaded by the second pressure prevailing in the reduced flow cross section at the constriction point or throttle point.

According to a further variant, the second effective area of the diaphragm is loaded by the first pressure prevailing between the second connection and the constriction point or throttle point.

Both variants of the invention make use of the effect that in the case of a flow through a flow duct from a flow cross section through an, in comparison, smaller flow cross section at a constriction point or throttle point, according to the law of continuity although the flow speed at the constriction point or throttle point, and therefore the dynamic ram pressure, rise, the static pressure is reduced. Furthermore, use is made of the effect that, in the case of a flow through the constriction point or throttle point, losses of flow energy occur which result in a static pressure which is reduced compared to the static pressure upstream of the constriction point or throttle point. The above-mentioned first, second and third pressures constitute here essentially static pressures.

Depending on the direction of flow in the flow duct—ventilation flow or bleeding flow—and depending on the arrangement of a connecting duct in which, depending on the variant, either the first pressure or the second pressure is present and said pressure then loads the second effective area of the diaphragm, different pressures arise with which the effective areas of the diaphragm of the diaphragm valve are loaded, thereby bringing about the open position or the closed position.

On the basis of his specialist knowledge, a person skilled in the art can suitably configure and dimension the first effective area, the second effective area, the pressure spring arrangement and the flow cross sections in the first section, in the second section and at the constriction point or throttle point of the flow duct so that the desired effects described above occur.

It is assumed that the pressures between the connections and the constriction point or throttle point or between the constriction point or throttle point and the connections do not change significantly even though pressure losses actually occur as a result of friction. If therefore mention is made above of a “first pressure prevailing in a second section of the flow duct between the second connection and the constriction point or throttle point” and of a “third pressure prevailing in a first section of the flow duct between the first connection and the constriction point or throttle point”, it is assumed in an idealized fashion that the first pressure along the second section and the third pressure along the first section each remain approximately of the same magnitude.

More precise details are apparent from the description of exemplary embodiments.

Advantageous developments and improvements of the invention specified herein are possible by virtue of the measures disclosed in the further descriptions herein.

According to one particular embodiment, a branch duct branches off from the first section of the flow duct, which may be in the perpendicular direction, and is connected at least to part of the first effective area of the diaphragm. In this way, the first effective area of the diaphragm is placed at least partially under the third pressure which prevails between the first connection and the constriction point or throttle point.

Particularly, at least in the open position of the diaphragm valve, a partial flow of the bleeding flow flows through the flow duct, and a further partial flow of the bleeding flow flows via the branch duct to the pressure sink. The geometry and arrangement of the first section of the flow duct and of the branch duct and, in particular, their flow cross sections are embodied in accordance with this. The bleeding of the pneumatic actuator then takes place, on the one hand, via the flow duct in the direction of the second connection and the pressure source and, on the other hand, via the branch duct and the pressure sink. The bleeding partial flow which is conducted via the flow duct and the second connection can then be bled, in particular, via a bleeding device arranged between the second connection and the compressed air source. If, for example, in the case of a pneumatic or electro-pneumatic brake system, a relay valve is arranged between the second connection and the pressure source, the partial bleeding flow which is directed via the flow duct can be bled by the bleeding device which is usually assigned to such a relay valve.

So that the second effective area of the diaphragm can be placed under the second pressure according to the first variant or under the first pressure according to the first variant, for example a chamber which is bounded by the second effective area of the diaphragm is connected by a connecting duct to the constriction point or throttle point according to the first variant or to the second section of the flow duct according to the second variant.

In this context, the connecting duct can be arranged essentially perpendicularly with respect to the second section of the flow duct or with respect to the constriction point or throttle point, in order to control as well as possible only a static first or second pressure at the second effective area of the diaphragm.

The diaphragm particularly may be held at its radially outer edge in the housing, for example between two housing halves of the housing, and interacts via an axially movable radially inner section with the valve seat.

According to one development, the valve seat is embodied as an edge of a mouth of a bleeding duct, connected to the pressure sink, in the housing, the bleeding duct being able to be arranged, for example, perpendicularly with respect to the flow duct. However, consequently any desired orientations of the bleeding duct or of the central axis of the diaphragm valve with respect to the flow duct or the central axis thereof are possible.

Accordingly, in the closed position of the diaphragm valve, part of the first effective area is loaded by the third pressure, and a further part by atmospheric pressure.

The invention also relates to a pneumatic or electro-pneumatic system of a vehicle, which system contains at least one quick-action bleeder valve device as described above. Such a system may be, for example, a pneumatic or electro-pneumatic brake system, an air suspension system or a pneumatically actuated clutch and/or transmission system of a vehicle. This enumeration is, of course, incomplete since one or more pneumatic actuators of any pneumatic or electro-pneumatic system can be bled by the quick-action bleeder device according to the invention.

The system particularly may be a pneumatic or electro-pneumatic brake system, wherein at least one quick-action bleeder device as described above is arranged between a working connection of a relay valve and at least one brake cylinder, wherein the first connection is connected to a brake chamber, which can be ventilated and bled, of the brake cylinder, and the second connection is connected to the working connection of the relay valve.

In this context, the quick-action bleeder device can be embodied separately, i.e. with its own housing, or can be integrated into the housing of the brake cylinder. The advantage of a separate embodiment of the quick-action bleeder device is that the remaining components of the system do not have to be changed and, in particular, the quick-action bleeder device can easily be retrofitted. Furthermore, the housing of the quick-action bleeder device can then also be embodied as an at least two-part housing, wherein the edge of the diaphragm of the diaphragm valve can then be clamped between the two housing parts.

In each case an exemplary embodiment of variants of the invention is illustrated below in the drawing and explained in more detail in the following description.

### BRIEF DESCRIPTION OF THE DRAWINGS

FIG. 1 shows a lateral sectional illustration of an exemplary embodiment of a first variant of the invention.

FIG. 2 shows the lateral sectional illustration of FIG. 1 with a ventilation flow and bleeding flow symbolized by arrows.

FIG. 3 shows a lateral sectional illustration of an exemplary embodiment of a second variant of the invention.

### DETAILED DESCRIPTION

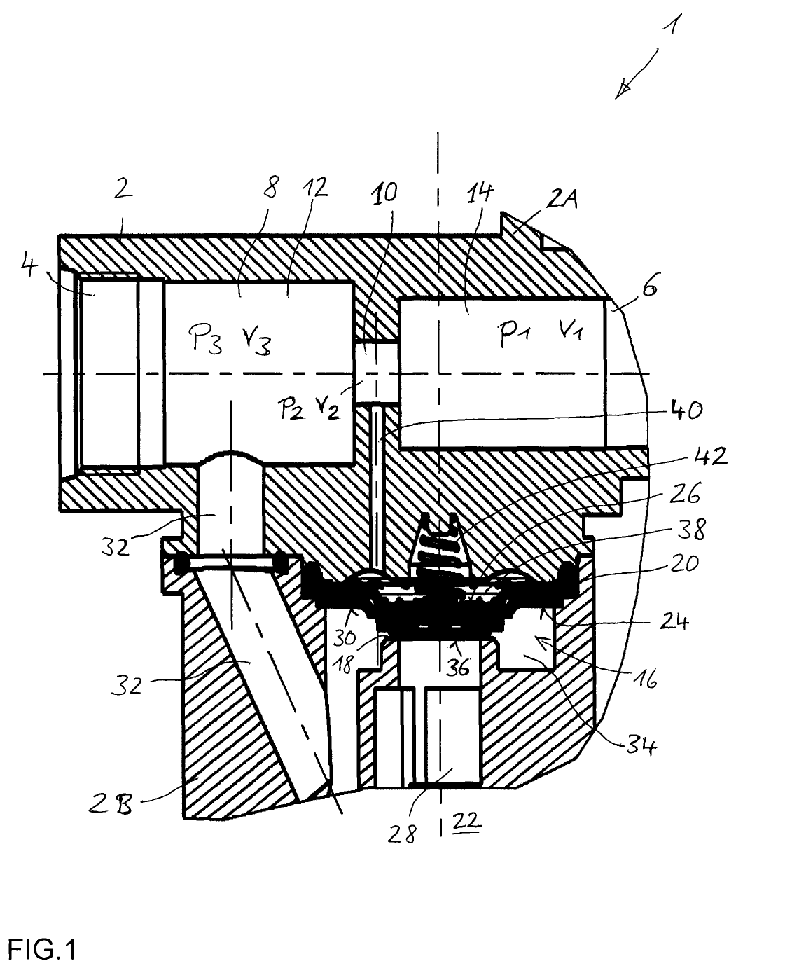

An exemplary embodiment shown in FIG. 1 of a first variant of a quick-action bleeder valve device 1 may serve to quickly bleed a pneumatic brake cylinder (not shown here for reasons of scale) of a pneumatic or electro-pneumatic brake system of a vehicle, in particular of a utility vehicle.

The quick-action bleeder valve device 1 may form here a separate device with a separate housing 2, a first connection 4 which can be connected to a brake chamber, which can be ventilated and bled, of the brake cylinder, and a second connection 6 which is connected to a working connection of a relay valve (not shown here). The relay valve is, for example, part of a pressure regulating module which is sufficiently known in electro-pneumatic brake systems, and said relay valve is connected via a supply connection to a compressed air source, in particular to a compressed air reservoir, and modulates a working pressure or brake pressure at its working connection as a function of the control pressure which is present at its pneumatic control connection and is generated by an inlet/outlet valve combination.

In the housing 2, a flow duct 8, which may be cylindrical and straight here, is formed between the first connection 4 and the second connection 6 and is constricted at a constriction point or throttle point 10 by a reduced flow cross section. In other words, the flow duct 8 has, in a first flow duct section 12 between the first connection 4 and the constriction point or throttle point 10 and in a second flow duct section 14 between the constriction point or throttle point 10 and the second connection 6, in each case a larger flow cross section than at the constriction point or throttle point 10. The transition from the respectively larger flow cross section of the first flow duct section 12 and of the second flow duct section 14 to the flow cross section of the constriction point or throttle point 10 which is smaller compared thereto may take place here in a stepped fashion. Alternatively, this transition can, however, also proceed in a constant and continuous fashion.

However, instead of being straight, the flow duct 8 can also be embodied so as to be curved in any desired fashion or partially straight with bending points.

In the housing 2, a diaphragm valve 16 is arranged which comprises at least one diaphragm 20 which interacts with a valve seat 18, wherein in an open position of the diaphragm valve 16, in which the diaphragm 20 is lifted off from the valve seat 18, a pressure sink 22 is connected to the first connection 4, and in a closed position of the diaphragm valve 16, in which the diaphragm 20 is seated on the valve seat 18 in a seal-forming fashion, this connection is interrupted, as can be easily imagined with reference to FIG. 1.

The diaphragm 20, which is, for example, in the shape of a circular surface, particularly may be held at its radially outer edge in the housing 2 and clamped, for example, between two housing halves 2A, 2B of the housing 2. The diaphragm 20 interacts via an axially movable radially inner section with the valve seat 18 and has a first effective area 24 and a second effective area 26 pointing away from the latter.

The valve seat 18 may be embodied as an edge of a mouth of a bleeding duct 28, connected to the pressure sink 22, for example the atmosphere, in the housing 2, wherein the bleeding duct 28 is arranged, for example, perpendicularly with respect to the flow duct 8. The bleeding duct 28 is embodied, for example, in the lower housing half 2B here, in which the valve seat 18 and the bleeding duct 28 are also formed, wherein during the mounting of the diaphragm valve 16 the diaphragm is positioned on the lower housing half 2B in contact with the valve seat and then in order to secure the diaphragm the upper housing half 2A is mounted on the lower housing half 2B with intermediate arrangement of the edge of the diaphragm 20.

Under pressure loading of the first effective area 24 of the diaphragm 20, the diaphragm valve 16 is pushed into the open position in which the diaphragm 20 is lifted off from the valve seat 18. In the closed position of the diaphragm valve which is shown, an annular area 30, bounded by the valve seat 18 on the inside and by the clamped edge on the outside, of the first effective area 24 is loaded by a third pressure p3 prevailing in the first flow duct section 12 between the first connection 4 and the constriction point or throttle point 10. So that the third pressure p3 can act on this annular area 30 of the first effective area 24 of the diaphragm, a branch duct 32 branches off from the first flow duct section 12, which may be in an initially perpendicular direction and then inclined at an acute angle to the vertical with respect to the flow duct 8, which branch duct 32 is connected to an annular chamber 34 which is bounded by the annular area 30 of the first effective area 24 of the diaphragm 20.

Therefore, the pressure forces which are based on the third pressure p3 act against the first effective area 24 in the opening direction of the diaphragm valve 16.

Furthermore, in the closed position, atmospheric pressure acts via the bleeding duct 28 on the inner part 36, bounded on the outside by the valve seat 18, of the first effective area 24. The pressure forces which are based on the atmospheric pressure act against the first effective area 24 therefore in the opening direction of the diaphragm valve 16.

Under pressure loading of the second effective area 26 of the diaphragm 20, the diaphragm valve 16 is pushed into the closed position in which the diaphragm 20 rests on the valve seat 18 in a seal-forming fashion. In the variant in FIG. 1, this second effective area 26 is loaded by a second pressure p2 prevailing in the reduced flow cross section at the constriction point or throttle point 10. So that the second effective area 26 of the diaphragm 20 can be placed under the second pressure p2, for example a chamber 38 which is bounded by the second effective area 26 of the diaphragm 20 is connected by a connecting duct 40 to the constriction point or throttle point 10. This connecting duct 40 may be arranged perpendicularly with respect to the flow duct 8, with the result that of the total pressure (static pressure and dynamic ram pressure) prevailing in the constriction point or throttle point 10 essentially only the static pressure p2 is present in the chamber 38.

Furthermore, the diaphragm 20 is pushed by a pressure spring 42 into the closed position which is supported, on the one hand, centrally on the diaphragm 20 and, on the other hand, on the base of the chamber 38, into which base the connecting duct 40 opens. The pressure spring 42 is then installed prestressed between the base of the chamber 38 and the diaphragm 20 or the valve seat 18 supporting the latter, in order to be able to apply pressure forces to the diaphragm 20 in the closing direction.

Consequently, the pressure forces which act on the second effective area 26 of the diaphragm 20 and originate from the pressure spring 42 and from the second pressure p2 push the diaphragm 20 against the valve seat 18 in order to move the diaphragm valve into its closed position or hold it there. In contrast, the pressure forces which act on the first effective area 24 and are based on the third pressure p3 and on the atmospheric pressure attempt to lift the diaphragm 20 off from the valve seat and to move the diaphragm valve 16 into its open position or hold it there.

As is shown in FIG. 1, the flow cross section in the first flow duct section 12 can be somewhat larger than the flow cross section in the second flow duct section 14. However, these flow cross sections can equally well be equal in size, and the reverse conditions can also apply.

Against this background, the method of functioning of the quick-action bleeder device 1 according to the first variant in FIG. 1 is as follows:

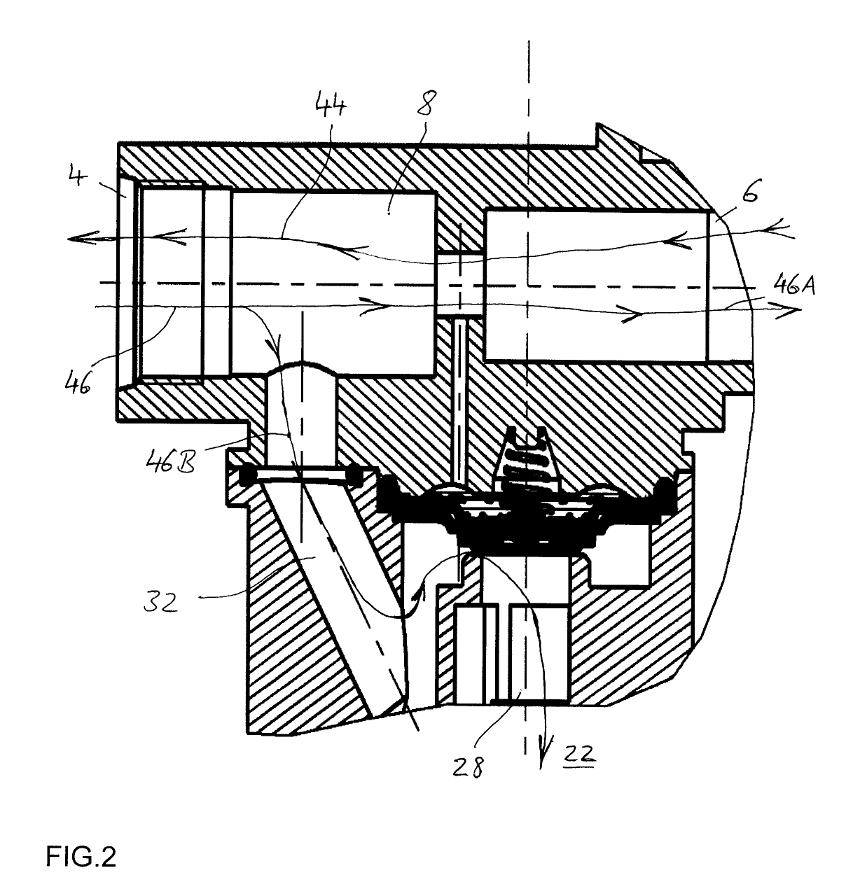

The first effective area 24, the second effective area 26, the pressure spring 42 and the flow cross sections in the first flow duct section 12, in the second flow duct section 14 and at the constriction point or throttle point 10 of the flow duct 8 are configured in such a way that, in the case of a ventilation flow, directed from the second connection 6 to the first connection 4 (symbolized in FIG. 2 by the first arrow 44), for ventilating the brake cylinder, the closing forces which act on the second effective area 26 and originate from the second pressure p2 as well as from that of the pressure spring 42 hold the diaphragm valve 16 in the closed position, or move it into said position, counter to the effect of the opening forces which act on the first effective area 24 and originate from the third pressure p3 and the atmospheric pressure.

In contrast, in the case of a bleeding flow, directed from the first connection 4 to the second connection 6 (symbolized in FIG. 2 by a second arrow 46), for bleeding the brake cylinder, the opening forces which act on the first effective area 24 and originate from the third pressure p3 and the atmospheric pressure hold the diaphragm valve 16 in the open position, or move it into said position, counter to the effect of the closing forces which act on the second effective area 26 and originate from the second pressure p2 and from the pressure spring 42.

Without the ventilation flow 44 and without the bleeding flow 46, the pressure forces of the prestressed pressure spring 42 are capable of holding the diaphragm valve 16 in the closed position.

The effects described above therefore originate from the fact that in the case of the flow through the flow duct 8 from a large flow cross section into the flow duct sections 12, 14 through an, in comparison, smaller flow cross section at the constriction point or throttle point 10, according to the law of continuity the flow speed v2 and therefore the dynamic ram pressure rise at the constriction point or throttle point 10, but the static second pressure p2 is reduced.

This effect is generally described by Bernoulli's law which describes the relationship between the flow speed v of a fluid and its static pressure p:

$$\frac{{v}^{2}}{2} + \frac{p}{ρ} = const$$

where the term

$$\frac{{v}^{2}}{2}$$

forms the dynamic pressure or ram pressure and the term

$$\frac{p}{ρ}$$

forms tne static pressure, where:

v is the flow speed,

p is the pressure, and

ρ is the density of the fluid.

In this context, it is assumed that the fluid is non compressible and that the flow is largely free of friction.

Analogously, the Venturi effect describes that the flow speed v of a fluid flowing through a flow duct behaves in an inversely proportional manner with respect to a changing pipe cross section. This means that the flow speed v of the fluid at cross-sectional constrictions increases because, according to the law of continuity, the same quantity of fluid which has been introduced into any flow cross section of a flow duct must exit said flow cross section.

Furthermore, in the invention, use is made of the effect that when there is a flow through the constriction point or throttle point 10 losses of flow energy occur which, compared with the static pressure p1 or p3 upstream of the constriction point or throttle point 10 result in a static pressure p1 or p3 which is reduced after the constriction point or throttle point 10 has been passed.

With respect to the example in FIG. 1, the above-mentioned laws mean for the ventilation flow 44 that the flow speed v1 which prevails in the second flow duct section 14 is increased at the constriction point or throttle point 10 to an, in comparison, higher flow speed v2, but the static pressure p1 prevailing in the second flow duct section 14 is reduced at the constriction point or throttle point 10 to an, in comparison, lower second pressure p2. After the flow cross section widens to the relatively large flow cross section in the first flow duct section 12, the flow speed drops from v2 to v3. However, the third pressure p3 in the first flow duct section 12 no longer reaches the output pressure p1 in the second flow duct section 14 owing to flow deflections and frictional losses at the constriction point or throttle point 10. Owing to this relatively large energy loss, the third pressure p3 in the first flow duct section 12 is then even lower than the second pressure p2 at the constriction point or throttle point 10, and the folloing applies: p3<p2.

The relatively low third pressure p3 which prevails in the first flow duct section 12 can then act on the annular area 30 of the first effective area 24 of the diaphragm 20 via the branch duct 32 and the annular chamber 34. Together with the pressure forces which load on the on the inner part 36 of the first effective area and are derived from the atmospheric pressure, the relatively low third pressure p3, is, however not capable of opening the diaphragm valve 16 counter to the effect of the closing forces which act on the second effective area 26 and originate from the relatively high second pressure p2 as well as from that of the pressure spring (in the case of the corresponding configuration), with the result that said diaphragm valve 16 remains in its closed position which is secured by the pressure spring 42 or is moved into said position.

On the other hand, the laws described above for the bleeding flow 46 which takes place in the opposite direction mean that the flow speed v3 which prevails in the first flow duct section 12 is increased at the constriction point or throttle point 10 to the, in comparison, higher flow speed v2, and the static pressure p3 prevailing in the first flow duct section 12 is reduced at the constriction point or throttle point 10 to the, in comparison, lower second pressure p2. Therefore, the following applies for the bleeding flow 46: p2<p3.

This relatively low second pressure p2 is then applied to the second effective area 26 of the diaphragm 20 via the connecting duct 40.

Therefore, in the case of a bleeding flow, directed from the first connection 4 to the second connection 6 (symbolized in FIG. 2 by the second arrow 46), for bleeding the brake cylinder, the opening forces which act at the first effective area 24 and originate from the relatively high third pressure p3 and the atmospheric pressure can hold the diaphragm valve in the open position, or move it into said position, counter to the effect of the closing forces which act on the second effective area 26 and originate from the relatively low second pressure p2 and from that of the pressure spring 42.

The sample shows that the ratio between the second pressure p2 and the third pressure p3 depends on the direction in which there is a flow through the flow duct 8, and accordingly said ratio is different or opposed for the ventilation flow 44 and the bleeding flow 46.

Particularly, in the open position of the diaphragm valve 16 a partial bleeding flow 46A, directed flow duct 8, of the bleeding flow 46 flows through the flow duct 8, and a further partial bleeding flow 46B, directed flow duct 8, of the bleeding flow 46 flows via the branch duct 32 to the bleeding duct 28. In the present case here of a pneumatic or electro-pneumatic brake system, as has already been described above, a relay valve is arranged between the second connection 6 and the pressure source. It is therefore possible for the partial bleeding flow 46A which is directed via the flow duct 8 to be bled by the bleeding device which is usually assigned to such a relay valve.

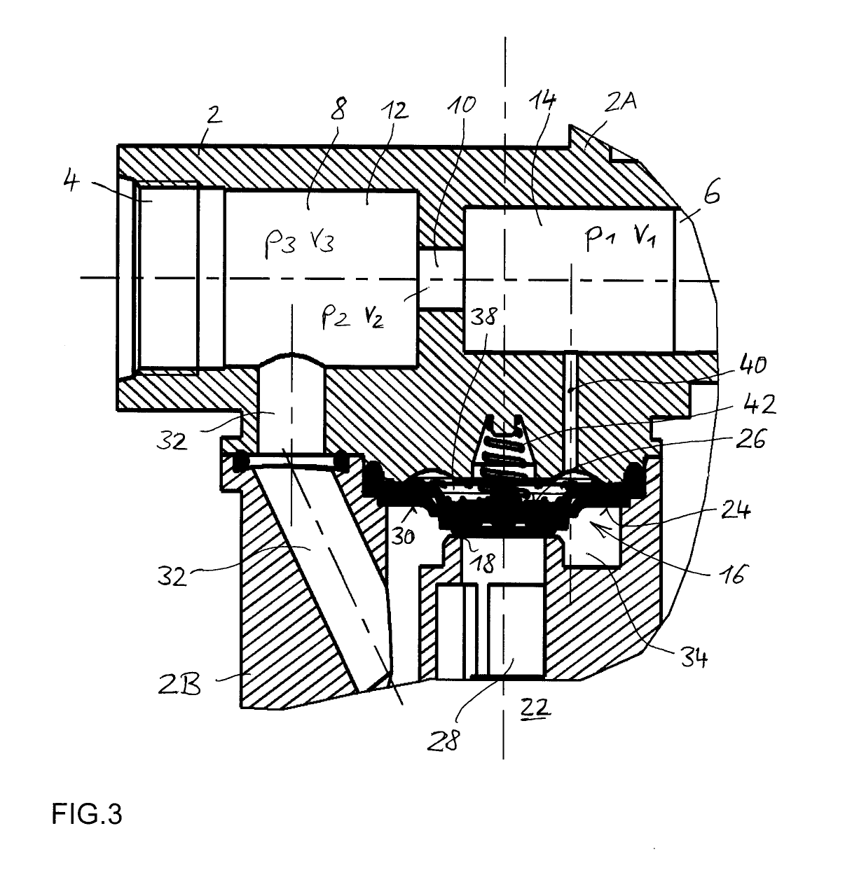

In the case of an exemplary embodiment (shown in FIG. 3) of a second variant of the quick-action bleeder device 1, identical or identically acting components and assemblies are characterized by the same reference numbers.

In contrast to the first variant, the second pressure p2 is not applied to the second effective area 26 but rather the first pressure p1 via a connecting duct 40 which is formed between the second flow duct section 14 and the chamber 38. This connecting duct 40 may be also arranged perpendicularly with respect to the flow duct 8. Therefore, the second effective area 26 of the diaphragm 20 is loaded in the closing direction by the first pressure p1 and by the pressure forces of the pressure spring 42, and the first effective area 24 continues to be loaded in the open direction by the third pressure p3 and the atmospheric pressure.

Against this background, the method of functioning of the quick-action bleeder device according to FIG. 3 is as follows:

The first effective area 24, the second effective area 26, the pressure spring 42 and the flow cross sections in the first flow duct section 12, in the second flow duct section 14 and at the constriction point or throttle point 10 of the flow duct 8 are configured in such a way that in the case of a ventilation flow, directed from the second connection 6 to the first connection 4, for ventilating the brake cylinder, the closing forces which act on the second effective area 26 and originate from the first pressure p1 and from that of the pressure spring 42 hold the diaphragm valve 16 in the closed position, or move it into said position, counter to the effect of the opening forces which act on the first effective area 24 and originate from the third pressure p3 and the atmospheric pressure.

In contrast, in the case of a bleeding flow directed from the first connection 4 to the second connection 6, for bleeding the brake cylinder, the opening forces which act on the first effective area 24 and originate from the third pressure p3 and the atmospheric pressure hold the diaphragm valve in the open position, or move it into said position, counter to the effect of the closing forces which act on the second effective area 26 and originate from the first pressure p1 and from that of the pressure spring 42.

With respect to the example in FIG. 3, this is a result of the fact that the flow speed v1 which prevails in the second flow duct section 14 is increased at the constriction point or throttle point 10 to the, in comparison, higher flow speed v2, but the static pressure p1 prevailing in the second flow duct section 14 is reduced at the constriction point or throttle point 10 to an, in comparison, lower second pressure p2. After the flow cross section widens again to the flow cross section in the first flow duct section 12, the flow speed drops from v2 to v3. However, the third pressure p3 in the first flow duct section 12 no longer reaches the output pressure p1 in the second flow duct section 14, owing to deflections of the flow and friction losses of the constriction point or throttle point 10. Owing to this energy loss, the third pressure p3 in the first flow duct section 12 is lower than the first pressure p1 in the second flow duct section 14: p3<p1.

The relatively low third pressure p3 which prevails in the first flow duct section 12 can then act on the annular area 30 of the first effective area 24 of the diaphragm 20 via the branch duct 32 and the annular chamber 34.

Therefore, in the case of the ventilation flow, the closing forces which act at the second effective area 26 of the diaphragm 20 and which originate from the relatively high first pressure p1 and from that of the pressure spring 42 (given a corresponding configuration) hold the diaphragm valve 16 in the closed position, or move it into said position, counter to the effect of the opening forces which act at the first effective area 24 and originate from the third pressure p3 and the atmospheric pressure.

On the other hand, this means for the bleeding flow which takes place in the opposite direction that owing to the friction effects and flow deflecting effects at the constriction point or throttle point 10, the first pressure p1 which prevails after the constriction point or throttle point 10 is lower than the third pressure p3 which prevails upstream of the constriction point or throttle point 10 in the first flow duct section 12. Therefore, the following applies for the bleeding flow: p1<p3.

This relatively low first pressure p1 is then applied to the second effective area 26 of the diaphragm 20 via the connecting duct 40. Therefore, this relatively low first pressure p1 is able, together with the pressure spring forces of the pressure spring 42 which do not impede diaphragm 20, to lift off from the valve seat 18 owing to the pressure forces acting in the opposite direction from the third pressure p3, which is then relatively high, and the atmospheric pressure, as a result of which in turn a partial bleeding flow is bled through the flow duct 8, and a further partial bleeding flow is bled through the bleeding duct 28.

### THE LIST OF REFERENCE NUMERALS IS AS FOLLOWS

1 Quick-action bleeder device

2 Housing

2A Housing half

2B Housing half

4 First connection

6 Second connection

8 Flow duct

10 Constriction point or throttle point

12 First flow duct section

14 Second flow duct section

16 Diaphragm valve

18 Valve seat

20 Diaphragm

22 Pressure sink

24 First effective area

26 Second effective area

28 Bleeding duct

30 Annular area

32 Branch duct

34 Annular chamber

36 Inner part

38 Chamber

40 Connecting duct

42 Pressure spring

44 Ventilation flow

46 Bleeding flow

46A Partial flow

46B Partial flow

1-13. (canceled)

14. A quick-action bleeder valve device for a pneumatic actuator of a pneumatic system, comprising:
a housing;
a first connection which is connectable to a chamber of the actuator, which chamber can be ventilated and bled;
a second connection which is connectable directly or indirectly to a compressed air source;
a flow duct, formed in the housing, between the first connection and the second connection, the flow duct being constricted at a constriction point or throttle point by a reduced flow cross section;
a diaphragm valve, arranged in the housing, including at least one diaphragm which interacts with a valve seat, wherein in an open position of the diaphragm valve, in which the diaphragm is lifted off from the valve seat, a pressure sink is connected to the first connection, and in a closed position of the diaphragm valve, in which the diaphragm is seated on the valve seat in a seal-forming fashion, this connection is interrupted;
wherein at least part of a first effective area of the diaphragm, which effective area pushes the diaphragm valve into the open position under pressure loading, is loaded at least by a third pressure prevailing in a first section of the flow duct between the first connection and the constriction point or throttle point,
wherein a second effective area of the diaphragm, which effective area pushes the diaphragm valve into the closed position under pressure loading, is loaded by a second pressure prevailing in the reduced flow cross section at the constriction point or throttle point or by a first pressure prevailing in a second section of the flow duct between the second connection and the constriction point or throttle point,
wherein the diaphragm is pushed into the closed position by a pressure spring arrangement, and
wherein the first effective area, the second effective area, the pressure spring arrangement and the flow cross sections in the first section, in the second section and at the constriction point or throttle point of the flow duct are configured so that:
(i) in the case of a ventilation flow, directed from the second connection to the first connection, for ventilating the pneumatic actuator by the compressed air source, the closing forces which act on the second effective area and originate from the second pressure or from the first pressure and from that of the pressure spring arrangement hold the diaphragm valve in the closed position, or move it into said position, counter to the effect of the opening forces which act on the first effective area and originate at least from the third pressure, and
(ii) in the case of a bleeding flow, directed from the first connection to the second connection, for bleeding the pneumatic actuator, the opening forces which act on the first effective area and originate at least from the third pressure hold the diaphragm valve in the open position, or move it into said position, counter to the effect of the closing forces which act on the second effective area and originate from the second pressure or from the first pressure and from that of the pressure spring arrangement.

15. The device of claim 14, wherein a branch duct branches off from the first section of the flow duct and is connected at least to part of the first effective area of the diaphragm.

16. The device of claim 15, wherein, at least in the open position of the diaphragm valve, a partial flow of the bleeding flow is bled through the flow duct, and a further partial flow of the bleeding flow is bled via the branch duct to the pressure sink.

17. The device of claim 14, wherein a chamber which is bounded by the second effective area of the diaphragm is connected by a connecting duct to the constriction point or throttle point or to the second section of the flow duct.

18. The device of claim 17, wherein the connecting duct is arranged essentially perpendicularly with respect to the second section of the flow duct or with respect to the constriction point or throttle point.

19. The device of claim 14, wherein the diaphragm is held at its radially outer edge in the housing, and interacts with an axially movable radially inner section with the valve seat.

20. The device of claim 14, wherein the valve seat includes an edge of a mouth of a bleeding duct, connected to the pressure sink, in the housing.

21. The device of claim 20, wherein the bleeding duct is arranged perpendicularly with respect to the flow duct.

22. The device of claim 14, wherein, in the closed position of the diaphragm valve, part of the first effective area is loaded by the third pressure, and a further part by atmospheric pressure.

23. A pneumatic system, comprising:
at least one quick-action bleeder valve device for a pneumatic actuator of a pneumatic system, including:
a housing;
a first connection which is connectable to a chamber of the actuator, which chamber can be ventilated and bled;
a second connection which is connectable directly or indirectly to a compressed air source,;
a flow duct, formed in the housing, between the first connection and the second connection, the flow duct being constricted at a constriction point or throttle point by a reduced flow cross section;
a diaphragm valve, arranged in the housing, including at least one diaphragm which interacts with a valve seat, wherein in an open position of the diaphragm valve, in which the diaphragm is lifted off from the valve seat, a pressure sink is connected to the first connection, and in a closed position of the diaphragm valve, in which the diaphragm is seated on the valve seat in a seal-forming fashion, this connection is interrupted;
wherein at least part of a first effective area of the diaphragm, which effective area pushes the diaphragm valve into the open position under pressure loading, is loaded at least by a third pressure prevailing in a first section of the flow duct between the first connection and the constriction point or throttle point,
wherein a second effective area of the diaphragm, which effective area pushes the diaphragm valve into the closed position under pressure loading, is loaded by a second pressure prevailing in the reduced flow cross section at the constriction point or throttle point or by a first pressure prevailing in a second section of the flow duct between the second connection and the constriction point or throttle point,
wherein the diaphragm is pushed into the closed position by a pressure spring arrangement, and
wherein the first effective area, the second effective area, the pressure spring arrangement and the flow cross sections in the first section, in the second section and at the constriction point or throttle point of the flow duct are configured so that:
(i) in the case of a ventilation flow, directed from the second connection to the first connection, for ventilating the pneumatic actuator by the compressed air source, the closing forces which act on the second effective area and originate from the second pressure or from the first pressure and from that of the pressure spring arrangement hold the diaphragm valve in the closed position, or move it into said position, counter to the effect of the opening forces which act on the first effective area and originate at least from the third pressure, and
(ii) in the case of a bleeding flow, directed from the first connection to the second connection, for bleeding the pneumatic actuator, the opening forces which act on the first effective area and originate at least from the third pressure hold the diaphragm valve in the open position, or move it into said position, counter to the effect of the closing forces which act on the second effective area and originate from the second pressure or from the first pressure and from that of the pressure spring arrangement.

24. The system of claim 23, wherein the system includes at least one of a pneumatic brake system, an electro-pneumatic brake system, an air suspension system, a pneumatically actuated clutch and a transmission system of a vehicle.

25. The system of claim 24, wherein the system is a pneumatic brake system or an electro-pneumatic brake system of a vehicle, and wherein the at least one quick-action bleeder device is arranged between a working connection of a relay valve and at least one brake cylinder, wherein the first connection is connected to a brake chamber, which can be ventilated and bled, of the brake cylinder, and the second connection is connected to a working connection of the relay valve.

26. The system of claim 25, wherein the quick-action bleeder device is configured separately or is integrated into the housing of the brake cylinder.
